(19) United States
(12) Patent Application Publication
(10) Pub. No.: US 2024/0364061 A1
(43) Pub. Date: Oct. 31, 2024

(54) PLUG-IN STRUCTURE OF BUSBAR AND TERMINAL, AND MOTOR VEHICLE

(71) Applicant: Changchun Jetty Automotive Technology Co., Ltd., Changchun, Jilin (CN)

(72) Inventors: Chao WANG, Changchun, Jilin (CN); Chuan LIU, Changchun, Jilin (CN)

(73) Assignee: Changchun Jetty Automotive Technology Co., Ltd., Changchun, Jilin (CN)

(21) Appl. No.: 18/684,172

(22) PCT Filed: Aug. 8, 2022
(86) PCT No.: PCT/CN2022/110787

§ 371 Date: Feb. 15, 2024

(30) Foreign Application Priority Data
Aug. 17, 2021 (CN) 202110944194.0

(51) Int. Cl. H01R 25/16

(52) U.S. Cl. CPC H01R 25/162; H01R 2201/26

(57) ABSTRACT

The present disclosure provides a plug-in structure of a busbar and a terminal, and a motor vehicle, relating to the technical field of electrical connection elements. The plug-in structure of the busbar and the terminal includes: a busbar and a plug-in terminal, the busbar is provided with a plug-in portion; the plug-in terminal includes at least one terminal lamination; the terminal lamination includes a plug-in end, and a connection end for being connected to a cable, and the plug-in portion is constructed to be in plug-in fit with the plug-in end. According to the present disclosure, the technical problem that the busbar can only be connected to other terminals or electrical devices through copper terminals is solved.

### RELATED APPLICATION

The present application claims priority to Chinese Patent Application NO. 202110944194.0, filed on Aug. 17, 2021, and entitled “Plug-in Structure of Busbar and Terminal, and Motor Vehicle”.

### TECHNICAL FIELD

The disclosure relates to the technical field of electrical connection elements, and in particular to a plug-in structure of a busbar and a terminal, and a motor vehicle.

### BACKGROUND

In the field of electrical connection, the cost of copper wire connection is getting higher and higher, and people are looking for a material with lower cost and excellent conductive performance to replace copper. As a metal with good electrical conductivity, aluminum can be used as an alternative material for the copper material and is more applied to the field of electrical connection.

In some use environments that do not require high cable flexibility, a solid busbar may be used instead of multi-core cables for easy installation. However, since aluminum is an active metal with a dense oxide film on its surface, generally metallic aluminum is not made into a plug-in joint, but it is necessary to connect a copper terminal at the end of the aluminum busbar to have plugging and unplugging connection with other terminals.

Due to the large potential difference between copper and aluminum, electrochemical corrosion is prone to occur, so the aluminum busbar and the copper terminal are usually connected by friction welding or ultrasonic welding, which is a complex process with high processing cost.

### SUMMARY

The present disclosure aims to provide a plug-in structure of a busbar and a terminal, and a motor vehicle, to solve the technical problem that the busbar can only be connected to other terminals or electrical devices through copper terminals.

The above purpose of the present disclosure can be achieved by configuring with the following technical solutions:

The disclosure provides a plug-in structure of a busbar and a terminal, including: a
busbar and a plug-in terminal;
the busbar is provided with a plug-in portion:
the plug-in terminal includes at least one terminal lamination:
the terminal lamination includes a plug-in end, and a connection end for being connected to a cable, and the plug-in portion is constructed to be in plug-in fit with the plug-in end.

The disclosure provides a motor vehicle including the plug-in structure of a busbar and a terminal described above.

The present disclosure has the following characteristics and advantages:
1. In the plug-in structure, a transition layer is capable of reducing electrochemical reaction that occurs between the busbar and the plug-in terminal, so as to solve the technical problem that the busbar can only be connected to other terminals or electrical devices through copper terminals.
2. Multiple terminal laminations are stacked. The terminal laminations are easy to deform and is capable of being plugged with the busbar. The busbar is in contact with the plug-in end of the terminal lamination to realize electrical connection, ensuring the stability of the connection of the plug-in terminal and the busbar.
3. Through the plug-in structure, the busbar realizes the function of the terminal by itself and is directly connected to the plug-in terminal, thereby solving the problem of high cost and low efficiency of the busbar connecting copper terminals, and achieving safe and fast plugging and unplugging.
4. The plug-in terminal of the present disclosure adopts tellurium-copper alloy, so that the terminal has good conductive performance and free-cutting property, thereby ensuring the electrical property and improving the processability, and the elasticity of the tellurium-copper alloy is also excellent.
5. The plug-in terminal of the present disclosure adopts a plating layer, which can better increase anti-corrosion performance, and exemplarily a composite plating layer is adopted to better improve the firmness of the plating layer, and after multiple times of plugging and unplugging, it is still possible to ensure non-falling and anti-corrosion performance of the plating layer.
6. The plating layer of the plug-in terminal of the present disclosure is set to have different materials and thicknesses. By setting the plating layer material and thickness at different positions of the plug-in terminal, the plating layer material can be saved and the cost of the terminal can be reduced.
7. A gap is arranged between the overhanging arms of the present disclosure to dissipate heat through the gap, so as to control the temperature rise between the busbar and the plug-in terminal.

### BRIEF DESCRIPTION OF THE DRAWINGS

The following drawings are intended only to schematically illustrate and explain the disclosure and do not limit the scope of the disclosure. In the drawings:

FIG. 1A and FIG. 1B are structural schematic diagrams of the plug-in structure of the busbar and terminal according to the present disclosure;

FIG. 2 is the structural schematic diagram of the busbar in the plug-in structure shown in FIG. 1A:

FIGS. 3 to 7 are structural schematic diagrams of the plug-in terminal of the plug-in structure according to an embodiment of the present disclosure.

### DESCRIPTION OF EMBODIMENTS

For a clearer understanding of the technical features, objects and effects of the present disclosure, specific embodiments of the present disclosure will now be described with reference to the accompanying drawings. In description of the present disclosure, “a plurality of” means two or more, unless otherwise indicated.

### First Solution

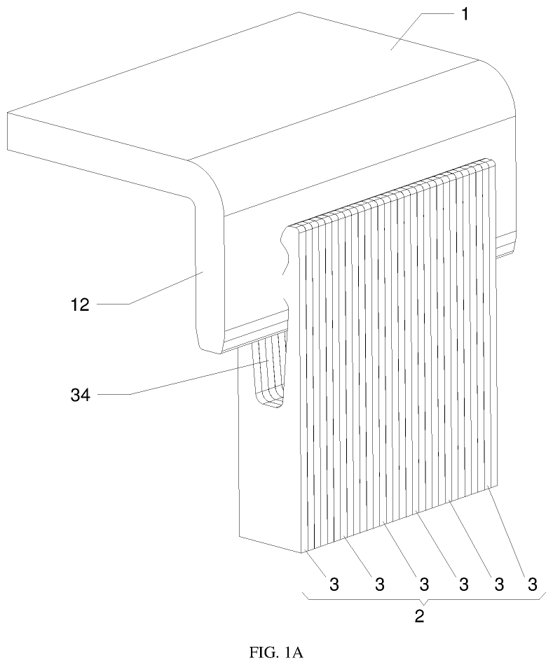

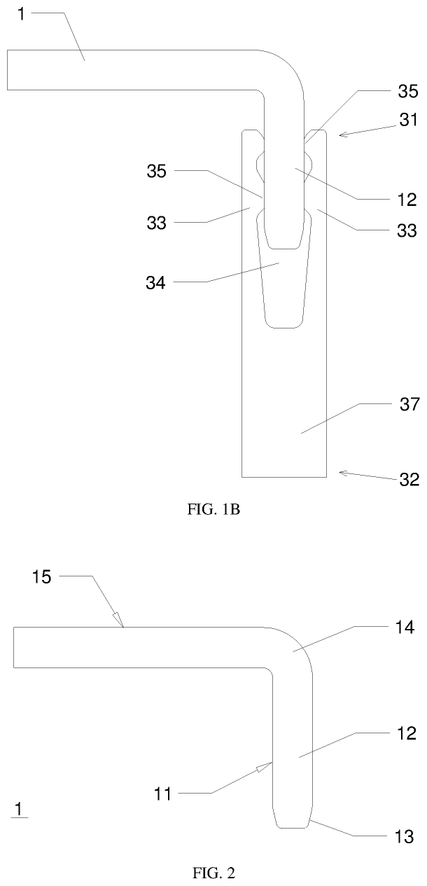

The disclosure provides a plug-in structure of a busbar and a terminal, as shown in FIGS. 1A to 3, including a busbar 1 and a plug-in terminal 2: the busbar 1 is provided with a plug-in portion 12: the plug-in terminal 2 includes at least one terminal lamination 3; the terminal lamination 3 has a plug-in end 31, and a connection end 32 for being connected to a cable; and the plug-in portion 12 is capable of being in plug-in fit with the plug-in end 31.

In an optional embodiment, the plug-in terminal 2 includes a plurality of terminal laminations, and the plurality of terminal laminations are stacked.

In an embodiment, the plug-in portion 12 is provided with a transition layer 11.

In the plug-in structure, the transition layer 11 can reduce electrochemical reaction between the busbar 1 and the plug-in terminal 2. The plurality of terminal laminations 3 are stacked. The terminal laminations 3 are easy to deform and are capable of being plugged with the busbar 1. The busbar 1 is in contact with the plug-in end 31 of the terminal lamination 3 to realize electrical connection, ensuring the stability of the connection of the plug-in terminal 2 and the busbar 1. Through the plug-in structure, the busbar 1 realizes the function of the terminal by itself and is directly connected to the plug-in terminal 2, thereby solving the problem of high cost and low efficiency of the busbar 1 connecting copper terminals, and achieving safe and fast plugging and unplugging.

In an embodiment, the transition layer 11 is attached to a surface of the plug-in portion 12 by one or more selected from electroplating, chemical plating, magnetron sputtering, vacuum plating, pressure welding, diffusion welding, friction welding, resistance welding, ultrasonic welding and laser welding.

Electroplating method refers to a process of plating a thin layer of other metals or alloys on some metal surface by the principle of electrolysis. Chemical plating refers to a process of metal deposition generated by controllable oxidation-reduction reaction under the catalysis of metals. Magnetron sputtering refers to that, using the interaction of magnetic field and electric field, the electrons travel in a spiral pattern near the surface of the target, thus increasing the probability of which the electrons hits the argon and produces ions. The generated ions hits the target surface under the action of electric field and sputters out the target material. Vacuum plating refers to that, under vacuum conditions, various metal films and non-metal films are deposited on the surface of the plastic parts by means of distillation or sputtering or the like. The pressure welding is a method of applying pressure to a weldment to make the binding surface be in contact closely to each other to produce a certain plastic deformation and complete the welding. The friction welding refers to a method of welding by using the heat generated by the friction of the contact surface of the workpiece as the heat source to make the workpiece produce plastic deformation under the action of pressure. The resistance welding refers to a method of welding by strong current passing through the contact point between the electrode and the workpiece to generate heat from the contact resistance. The ultrasonic welding refers to that high-frequency vibration wave is transmitted to the surfaces of two objects to be welded, and under pressurization, the surfaces of two objects rub against each other to form a fusion between molecular layers. The laser welding refers to an efficient and precise welding method using a laser beam with high energy density as a heat source. The diffusion welding refers to a solid-state welding method that pressurizes the workpiece at high temperature, but the visible deformation and relative movement are not produced. By the above various methods or combination thereof, the transition layer 11 can be stably arranged on the surface of the plug-in portion 12.

In an embodiment, a thickness of the transition layer 11 is 0.3 μm to 3000 μm; exemplarily, a thickness of the transition layer 11 is 2.5 μm to 1000 μm.

In order to test the influence of different thicknesses of the transition layer 11 on the voltage drop, the inventor uses the plug-in terminals of the same material and the same structure and provides with the transition layers 11 of different thicknesses on the busbar respectively, and then test the voltage drop after the plug-in connection.

In this embodiment, the voltage drop of the plug-in structure of the busbar and the terminal is less than 4 mV, which is regarded as being unqualified.

TABLE 1
Influence of different thicknesses of transition layer on voltage drop (mV): Thicknesses of transition layer (μm)

| Serial | 0.2 | 0.3 | 1 | 2.5 | 5 | 10 | 50 | 100 | 300 | 500 | 800 | 1000 | 2000 | 3000 | 4000 |
|---|---|---|---|---|---|---|---|---|---|---|---|---|---|---|---|
| No.: | Voltage drop after plug-in connection (mV) | | | | | | | | | | | | | | |
| 1 | 4.1 | 3.4 | 3.3 | 3.1 | 3.2 | 3.4 | 3.5 | 3.6 | 3.6 | 3.7 | 3.8 | 3.8 | 3.8 | 3.8 | 4.1 |
| 2 | 4.0 | 3.5 | 3.3 | 3.2 | 3.3 | 3.5 | 3.6 | 3.5 | 3.6 | 3.6 | 3.7 | 3.8 | 3.9 | 3.9 | 4.1 |
| 3 | 4.2 | 3.4 | 3.2 | 3.1 | 3.2 | 3.4 | 3.5 | 3.7 | 3.5 | 3.7 | 3.8 | 3.8 | 3.8 | 3.8 | 4.0 |
| 4 | 4.1 | 3.5 | 3.4 | 3.1 | 3.1 | 3.4 | 3.6 | 3.6 | 3.7 | 3.7 | 3.8 | 3.8 | 3.8 | 3.9 | 4.1 |
| 5 | 4.2 | 3.4 | 3.3 | 3.2 | 3.2 | 3.5 | 3.5 | 3.6 | 3.7 | 3.8 | 3.8 | 3.8 | 3.8 | 3.8 | 4.2 |
| 6 | 4.0 | 3.4 | 3.2 | 3.1 | 3.3 | 3.4 | 3.5 | 3.6 | 3.6 | 3.7 | 3.7 | 3.7 | 3.7 | 3.9 | 4.2 |
| 7 | 4.2 | 3.6 | 3.3 | 3.1 | 3.2 | 3.6 | 3.4 | 3.6 | 3.6 | 3.7 | 3.8 | 3.8 | 3.8 | 3.8 | 4.0 |
| 8 | 4.1 | 3.4 | 3.4 | 3.1 | 3.3 | 3.4 | 3.5 | 3.7 | 3.7 | 3.8 | 3.7 | 3.7 | 3.9 | 3.9 | 4.1 |
| 9 | 4.2 | 3.4 | 3.2 | 3.2 | 3.3 | 3.3 | 3.5 | 3.6 | 3.6 | 3.7 | 3.7 | 3.8 | 3.8 | 3.9 | 4.2 |
| 10 | 4.2 | 3.5 | 3.3 | 3.1 | 3.3 | 3.4 | 3.6 | 3.6 | 3.8 | 3.7 | 3.7 | 3.7 | 3.9 | 3.9 | 4.1 |
| Average | 4.13 | 3.45 | 3.29 | 3.13 | 3.24 | 3.42 | 3.52 | 3.62 | 3.64 | 3.71 | 3.75 | 3.77 | 3.82 | 3.86 | 4.11 |
| value | | | | | | | | | | | | | | | |

It can be seen from the data in Table 1 that when a thickness of the transition layer 11 is greater than 3000 μm or less than 0.3 μm, the voltage drop of the plug-in structure between the busbar and the terminal is less than 4 mV, which does not meet the required value, and the mechanical property and electrical property of the plug-in structure decline at that time. Therefore, the inventor selects the thickness of the transition layer 11 to be 0.3 μm to 3 mm. When a thickness of the transition layer 11 is in the range of 2.5 μm to 1000 μm, the voltage drop of the plug-in structure of the busbar and the terminal is the optimal value. Therefore, exemplarily the inventor selects the thickness of the transition layer 11 to be 2.5 μm to 1000 μm.

In an embodiment, a material of the transition layer 11 includes one or more selected

from nickel, cadmium, manganese, zirconium, cobalt, tin, titanium, chromium, gold, silver, zinc, tin-lead alloy, silver-antimony alloy, palladium, palladium-nickel alloy, graphite-silver, graphene-silver, and silver-gold-zirconium alloy.

In order to demonstrate the influence of different materials of the transition layer 11 on the overall performance of the busbar 1, the inventor adopts samples of the plug-in terminal 2 with the same specification and material, and different materials of the transition layer 11, and performs a series of tests of number of times of plugging and unplugging and corrosion resistance time by using the busbars 1 with the same specification. In order to prove the advantages and disadvantages of the selected materials and other commonly used materials of the transition layer 11, the inventor also selects tin, nickel and zinc as the materials of the transition layer 11 for the experiment. The experimental results are shown in Table 2.

The number of times of plugging and unplugging in the Table 2 means that the busbars 1 are fixed on the experiment table respectively, and the plug-in terminal 2 simulates plugging and unplugging by using a mechanical device, and after every 100 times of plugging and unplugging, it is necessary to stop and observe the damage of the transition layer 11 on the surface of the busbar 1. When the transition layer 11 of the busbar 1 is scratched and the material of the busbar 1 itself is exposed, the experiment is stopped and the number of times of plugging and unplugging at that time is recorded. In this embodiment, if the number of times of plugging and unplugging is less than 8000, it shows an unqualified product.

The test of corrosion resistance time in the Table 2 refers to, putting the busbar 1 into a salt fog spraying test chamber to spray salt fog to each position of the busbar 1 and then taking the busbar 1 out every 20 hours to clean the busbar 1 and observe surface corrosion of the busbar 1, at that time a cycle ends, and when the corrosion area of the surface of the busbar 1 is greater than 10% of the total area, stopping the test and recording the number of cycles at that time. In this embodiment, the number of cycles less than 80 is considered as being unqualified.

TABLE 2
Influence of different materials of the transition layer on the number of
times of plugging and unplugging and corrosion resistance of the busbar
Different materials of the transition layer

| | | | | | | | | |
|---|---|---|---|---|---|---|---|---|
| Nickel | Cadmium | Manganese | Zirconium | Cobalt | Tin | Titanium | Zinc | Chromium |

Number of Times of Plugging And Unplugging (times)

| | | | | | | | | |
|---|---|---|---|---|---|---|---|---|
| 8300 | 11800 | 13200 | 12000 | 12600 | 8200 | 12000 | 8500 | 9000 |

Number of periods of corrosion resistance test (times)

| | | | | | | | | |
|---|---|---|---|---|---|---|---|---|
| 89 | 127 | 121 | 131 | 124 | 85 | 121 | 86 | 106 |

Different materials of the transition layer

| | | | | | | | | |
|---|---|---|---|---|---|---|---|---|
| Gold | Silver | Silver- | Graphite- | Graphene- | Silver-gold- | Palladium | Palladium- | Tin- |
| | | antimony | silver | silver | zirconium | | nickel | lead |
| | | Alloy | | | Alloy | | Alloy | Alloy |

Number of Times of plugging And Unplugging (times)

| | | | | | | | | |
|---|---|---|---|---|---|---|---|---|
| 12400 | 11800 | 13200 | 12000 | 12600 | 12000 | 11100 | 12000 | 10200 |

Number of Periods of Corrosion Resistance Test (times)

| | | | | | | | | |
|---|---|---|---|---|---|---|---|---|
| 132 | 127 | 121 | 131 | 124 | 132 | 111 | 121 | 112 |

As can be seen from the Table 2, when the material of the transition layer 11 includes commonly used metallic such as tin, nickel and zinc, the experimental results are slightly worse than those of other selected metals. When other metals are selected, the experimental results are more than the standard value, and the performance is stable. Therefore, the inventor selects the material of the transition layer 11 to include one or several selected from nickel, cadmium, manganese, zirconium, cobalt, tin, titanium, chromium, gold, silver, zinc, tin-lead alloy, silver-antimony alloy, palladium, palladium-nickel alloy, graphite-silver, graphene-silver, and silver-gold-zirconium alloy. More exemplarily, the inventor selects the material of the transition layer 11 to include one or several selected from cadmium, manganese, zirconium, cobalt, titanium, chromium, gold, silver, tin-lead alloy, silver-antimony alloy, palladium, palladium-nickel alloy, graphite-silver, graphene-silver, and silver-gold-zirconium alloy.

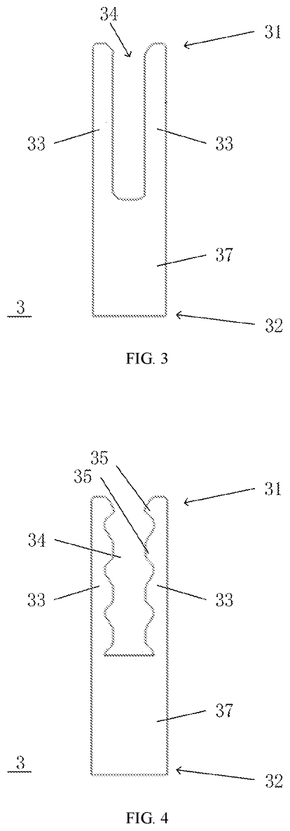

In an embodiment, the plug-in end 31 of the terminal lamination 3 is provided with at least two connection arms 33, and each connection arms 33 is fixedly connected to each other, a plugging slot 34 is arranged between two adjacent connection arms 33, the plug-in portion 12 can be plugged into the plugging slot 34 and electrically connected to the connection arm 33, to tightly clamp the plug-in portion 12 of the busbar 1 through the connection arm 33 and to fix the busbar 1 and the plug-in terminal 2 together, and to ensure a large contact area between the busbar 1 and the plug-in terminal 2, thereby ensuring the reliability of electrical connection. By adjusting the width of the connection arm 33 or the number of the terminal lamination 3, the clamping force is controlled so as to be easily adapted to the busbar 1 and to meet various mutual plugging requirements. As shown in FIGS. 3 and 4, the terminal lamination 3 includes two connection arms 33, a plugging slot 34 is formed between the two connection arms 33, and the busbar 1 can be plugged into the plugging slot 34. The number of the connection arms 33 of the terminal lamination 3 may be three or more. The terminal lamination 3 includes a plurality of plugging slots 34, and a plurality of busbars 1 are all in plug-in fit with the plug-in terminal 2.

In some embodiments, the gap between the connection arms of two adjacent terminal laminations 3 is smaller than 0.2 mm. The gap is provided between the connection arms 33, one purpose of which is to make air circulate between the adjacent connection arms, to reduce the temperature rise between the busbar 1 and the plug-in terminal 2, protect the transition layer 11 and the plating layer of the plug-in structure, and prolong the service life of the plug-in structure: the other purpose of which is to release the elasticity of the connection arm 33 itself and ensure the clamping force between the opposite connection arms 33, thereby also ensuring the plugging force between the busbar 1 and the plug-in terminal 2. However, it is not that the larger the gap between the adjacent connection arms 33 is, the better it is, and when the gap between the connection arms 33 of the two adjacent terminal laminations 3 is greater than 0.2 mm, the heat dissipation function thereof is not increased, but in stead, the connection arms 33 with the same contact area occupies a larger width and thus wastes use space. In addition, because the terminal fixing portions are fitted and connected to each other, the connection arms with the same contact area may expend a larger volume of the terminal fixing portions, thereby increasing the amount of the terminals and increasing the cost of the plug-in structure.

In some embodiments, at least part of the connection arm 33 is made of memory alloy. The memory alloy is a kind of intelligent metal with memory, and its microstructure has two relatively stable states. Such alloy is capable of being changed into any desired shape at high temperature, and is capable of being stretched at low temperature. But if the alloy is reheated, the alloy may remember its original shape and may be changed back. The memory alloy has different crystal structures above and below its transition temperature. However, when the temperature changes above and below the transition temperature, the memory alloy may contract or expand to make its shape change.

In some embodiments, the memory alloy has a transition temperature of 40° C. to 70° C., and when the temperature of the connection arm 33 is lower than the transition temperature, a plurality of connection arms 33 are in an expanded state: when the temperature of the connection arm 33 is higher than the transition temperature, a plurality of connection arms 33 are in a clamped state.

Under normal circumstances, the transition temperature is 40° C. to 70° C., because if the transition temperature is lower than 40° C., the environmental temperature of the plug-in terminal 2 may also reach nearly 40° C. in the absence of conductive current. In this case, the plurality of connection arms 33 are in the clamped state, the plugging slot 34 of the plug-in terminal 2 becomes smaller, and the busbar 1 cannot be inserted into the plugging slot 34, and as a result, the plug-in structure of the busbar 1 and the plug-in terminal 2 cannot be inserted and thus cannot work.

In some embodiments, the memory alloy is nickel-titanium alloy.

At ambient temperature, the busbar 1 is plugged into the plug-in terminal 2 and the conduct electricity is started. At the beginning of plugging, the plurality of connection arms 33 are in an expanded state, so the contact area of the busbar 1 and the plug-in terminal 2 is small and the current is large, which causes the connection arm 33 to heat up after plugging connection. If the transition temperature is higher than 70° C., the temperature rise time of the terminal is long, and the plug-in structure of the busbar 1 and the plug-in terminal 2 is in the high current state for a long time, which may easily cause electrical aging, and in serious cases, the plug-in structure of the busbar 1 and the plug-in terminal 2 may be overloaded and damaged, causing unnecessary losses.

Therefore, under normal circumstances, the transition temperature of the memory alloy is set 40° C. to 70° C.

In an embodiment, the connection end 32 is provided with a terminal fixing portion 37, and one end of each connection arm 33 is fixedly connected to the terminal fixing portion 37, and the connection arm 33 is connected to the cable through the terminal fixing portion 37 to ensure the stability of the electrical connection. The terminal fixing portion 37 is connected to the conductive portion of the cable by crimping connection, welding connection, threaded connection, rivet connection, or splicing connection.

The structure form of the terminal fixing portion 37 is not limited to one. The first form is that the terminal fixing portion 37 is an integrated structure, and one end of each connection arm 33 is fixedly connected to the terminal fixing portion 37. The second form is that the terminal fixing portion 37 is a part of the connection arm 33, and in each terminal lamination 3, the terminal fixing portion 37 is formed integrally with the connection arm 33, and a plurality of terminal fixing portions 37 of the plug-in terminal 2 are disposed to be stacked.

On the basis of the above second form, the inventor makes a further improvement that the terminal fixing portions 37 of the two adjacent terminal laminations 3 are connected to each other by crimping connection, welding connection, screwing connection, rivet connection or splicing connection to ensure the stability of the electrical connection.

The crimping connection refers to a production process in which the terminal fixing portion 37 and the cable are stamped into one body or the terminal fixing portions 37 of the two adjacent terminal laminations 3 are stamped into one body after being assembled, by using a crimping machine. The advantage of crimping connection is mass production, and a large amount of products with stable quality can be produced quickly by using an automatic crimping machine.

The welding connection refers to that, by friction welding, resistance welding, ultrasonic welding, arc welding, pressure welding, laser welding or explosive welding, the terminal fixing portion 37 and the cable are melted into an entirety or the terminal fixing portions 37 of the two adjacent terminal laminations 3 are melted into an entirety through metal spot weld, thereby achieving firm connection and small contact resistance.

The threaded connection refers to that, there is a thread structure between the terminal fixing portion 37 and the cable, or between the terminal fixing portions 37 of the two adjacent terminal laminations 3 respectively, each of which is capable of being threaded to each other or connected to each other by using separate studs and nuts. The advantage of the threaded connection is detachability, and assembling and disassembling can be performed repeatedly, which is suitable for scenarios that require frequent disassembly.

The riveting connection refers to that, the terminal fixing portion 37 and the cable are riveted to each other or the terminal fixing portions 37 of the two adjacent terminal laminations 3 are riveted to each other by using rivets, which has advantages of firm connection, simple processing method and easy operation.

The splicing connection refers to that, the terminal fixing portion 37 is provided with a clamping slot, the cable is provided with a clamping claw, or the two adjacent terminal laminations 3 are provided with a clamping slot and a clamping claw respectively, and then the clamping slot and the clamping claw are spliced to be connected to each other. The splicing connection method has advantages of fast connection and detachability.

In an embodiment, the connection arms 33 of the two adjacent terminal connection 3 are in contact fit with each other, and the connection arm 33 of each terminal lamination 3 is capable of sliding relatively to each other, so that the terminal laminations 3 maintain their own clamping force, and is capable of taking advantage of the characteristic of uneven surface of the plug-in terminal 2 to improve the stability of the connection.

In an embodiment, a plurality of protrusion portions 35 are provided on the inner side of the connection arm 33. As shown in FIG. 4, the plurality of protrusion portions 35 are distributed at intervals along the extending direction of the connection arms 33. When the busbar 1 is in plugging with the connection arm 33, the top surface of the protrusion portion 35 abuts against the busbar 1, the connection arm 33 is connected to the busbar 1 more closely, thereby improving the reliability of mechanical connection and electrical connection between the busbar 1 and the plug-in terminal 2.

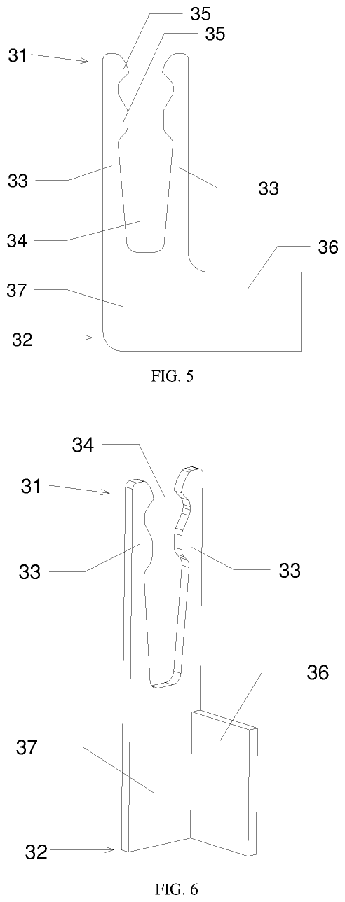

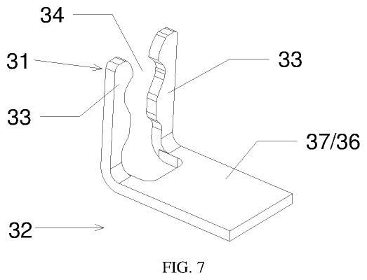

Further, the terminal lamination 3 includes a bending extension portion 36 arranged in a plane or a non-plane, with a bending angle of 0° to 180° to facilitate adaptation to different wiring directions. As shown in FIGS. 5 to 7, the angle between the connection arm 33 and the bending extension portion 36 is denoted as the bending angle. The terminal lamination 3 may be stamped such that various angles are formed between the connection arm 33 and the bending extension portion 36. As shown in FIG. 5, the bending extension portion 36 and the connection arm 33 are in the same plane, and the bending angle between the extension directions of the bending extension portion 36 and the connection arm 33 is exemplarily 90°. As shown in FIGS. 6 and 7, the bending extension portion 36 and the connection arm 33 of the fixing body portion of the terminal lamination 3 are not in the same plane. The bending extension portions 36 are bent and extended in non-plane, and the bending angle between the extension directions of the two is exemplarily 90°.

The main body of the busbar 1 is a solid flat core and an insulation layer 15 wrapping around the outer circumference. The plug-in portion 12 is located at the end of the busbar 1, and the surface of the plug-in portion 12 has no insulation layer 15. In an embodiment, as shown in FIGS. 1A and 2, the busbar 1 includes a bending portion 14 on which a transition layer 11 is arranged. The main body of the busbar 1 is connected to the plug-in portion 12 through the bending portion 14, and the extension direction of the busbar 1 is adjusted through the bending portion 14 to facilitate the adaptation of the busbar 1 to the installation environment.

In some embodiments, as shown in FIG. 2, the front end of the plug-in portion 12 is provided with a chamfer 13, which in some other embodiments may be replaced by a rounding chamfer, and the chamfer 13 or the rounding chamfer may guide the plug-in of the connection arm 33 and the busbar 1.

In some embodiments, the material of the terminal laminate 3 includes tellurium, and the terminal lamination 3 is made of tellurium-copper alloy, so that the terminal has good conductive performance and free-cutting property, thereby ensuring the electrical property and improving the processability.

Further, the content of tellurium in the material of the terminal lamination 3 is 0.1% to 5%, which ensures the conductive performance, and the elasticity of the tellurium-copper alloy is also excellent. Exemplarily, the content of tellurium in the tellurium-copper alloy is 0.2% to 1.2%.

The inventor selects ten terminal laminations 3 of the same shape for testing, and the terminal laminations 3 have the same size. The plug-in terminals 2 have the same number of terminal laminations 3. The terminal laminations 3 are all made of tellurium-copper alloy, in which the content proportions of tellurium are 0.05%, 0.1%, 0.2%, 0.5%, 0.8%, 1.2%, 2%, 3%, 5%, 6%, and 7%. After the busbar 1 is mutually plugged with the plug-in terminal 2, the plug-in structure is energized, and the electric conductivity at the mutual plugging position is detected, and the test results are shown in Table 3. In this embodiment, the electric conductivity greater than 99% is an ideal value.

As can be seen from Table 3, when the content of tellurium is less than 0.1% or greater than 5%, the electric conductivity decreases significantly, which cannot meet the requirement of the ideal value of the electric conductivity. When the content of tellurium is greater than or equal to 0.2% and less than or equal to 1.2%, the conductive performance is the best: when the content of tellurium is greater than 0.1% and less than 0.2%, or greater than 1.2% and less than or equal to 5%, although the electric conductivity meets the ideal value requirement, a declining trend appears, and the conductive performance will also decline. Therefore, the inventor selects a tellurium-copper alloy with a tellurium content of 0.1% to 5%. Most ideally, a tellurium-copper alloy with a tellurium content of 0.2% to 1.2% is selected.

TABLE 3
Influence of tellurium-copper alloys with different
tellurium contents on electric conductivity

| | Tellurium content | | | | | | | | | | |
|---|---|---|---|---|---|---|---|---|---|---|---|
| | 0.05 | 0.1 | 0.2 | 0.5 | 0.8 | 1.2 | 2 | 3 | 5 | 6 | 7 |
| Electric | 98.4 | 99.2 | 99.6 | 99.7 | 99.8 | 99.7 | 99.5 | 99.5 | 99.1 | 98.9 | 98.6 |
| conductivity | | | | | | | | | | | |
| (%) | | | | | | | | | | | |

In some embodiments, the terminal lamination 3 is made of beryllium-copper alloy.

In some embodiments, the content of beryllium in the material of the terminal lamination 3 is 0.05% to 5%.

Further, the content of beryllium in the material of the terminal lamination 3 is 0.1% to 3.5%.

The terminal lamination 3 includes beryllium, so that the terminal lamination 3 has a very high hardness, elastic limit, fatigue limit and wear resistance, but also has good corrosion resistance, thermal conductivity and electrical conductivity, and does not produce sparks when being impacted.

In order to test the influence of beryllium content on the electric conductivity of the terminal lamination 3, the inventor selects ten terminal laminations 3 with the same shape and the same width of expansion and contraction seam for testing, and each terminal lamination 3 includes beryllium, in which the content proportions of beryllium are 0.03%, 0.05%, 0.1%, 0.2%, 1%, 1.8%, 3%, 3.5%, 5%, and 6%. The test results are shown in Table 4.

TABLE 4
Influence of different contents of beryllium on electric conductivity

| | Contents of beryllium | | | | | | | | | |
|---|---|---|---|---|---|---|---|---|---|---|
| | 0.03% | 0.05% | 0.1% | 0.2% | 1% | 1.8% | 3% | 3.5% | 5% | 6% |
| Electric | 98.9% | 99.2% | 99.5% | 99.6% | 99.8% | 99.6% | 99.3% | 99.3% | 99.1% | 98.7% |
| conductivity | | | | | | | | | | |

As can be seen from Table 4, when the content of beryllium is less than 0.05% or greater than 5%, the electric conductivity decreases significantly, which cannot meet the actual demand. When the content of beryllium is greater than or equal to 0.1% and less than or equal to 3.5%, the conductive performance is the best, so the inventor selects the terminal laminations 3 with the content of beryllium of 0.1% to 5%. In the most ideal case, the terminal lamination 3 with the content of beryllium of 0.1% to 3.5% is selected.

In some embodiments, there is a plating layer on at least the plug-in end 31 on the terminal lamination 3 to improve corrosion resistance, improve conductive performance, increase number of times of plugging, and better prolong the service life of the plug-in structure.

In some embodiments, a material of the plating layer includes one or more selected from gold, silver, nickel, tin, zinc, tin-lead alloy, silver-antimony alloy, palladium, palladium-nickel alloy, graphite-silver, graphene-silver and silver-gold-zirconium alloy. Copper is an active metal, thus an oxidation reaction may occur between copper and oxygen and water during use, therefore, one or more inactive metals are needed as a plating layer to prolong the service life of the plug-in terminal 2. In addition, for a metal contact point that needs to be plugged frequently, a better wear-resistant metal is needed to serve as the plating layer, which can greatly prolong the service life of the contact point. In addition, the contact point needs excellent conductive property, and the electric conductivity and stability of the metals mentioned above are better than that of copper or copper alloys, which can make the plug-in terminal 2 obtain better electrical property and longer service life.

In order to demonstrate the influence of different plating layer materials on the overall performance of the terminal, the inventor adopts samples of the plug-in terminal 2 with the same specification and material, and different plating layer materials, and performs a series of tests of number of times of plugging and unplugging and corrosion resistance time by using the busbars 1 with the same specification. In order to prove the advantages and disadvantages of the selected materials and other commonly used electroplating materials, the inventor also selects tin, nickel and zinc as the plating layer materials for the experiment. The experimental results are shown in Table 5.

The number of times of plugging and unplugging in the Table 5 refers to that the plug-in terminals 2 are fixed on the experiment table respectively, and the busbar 1 simulates plugging and unplugging by using a mechanical device, and after every 100 times of plugging and unplugging, it is necessary to stop and observe the damage of the surface plating layer of the plug-in terminal 2. When the plating layer of the terminal surface is scratched and the material of the terminal itself is exposed, the experiment is stopped and the number of times of plugging and unplugging at that time is recorded. In this embodiment, if the number of times of plugging and unplugging is less than 8000, it shows an unqualified product.

The test of corrosion resistance time in the Table 5 refers to, putting the plug-in terminal 2 into a salt fog spraying test chamber to spray salt fog to each position of the plug-in terminal 2 and then taking the plug-in terminal 2 out every 20 hours to clean the plug-in terminal 2 and observe surface corrosion of the plug-in terminal 2, at that time a cycle ends, and when the corrosion area of the surface of the plug-in terminal 2 is greater than 10% of the total area, stopping the test and recording the number of cycles at that time. In this embodiment, the number of cycles less than 80 is considered as being unqualified.

TABLE 5
Influence of different plating layer materials on the number of times
of plugging and unplugging and corrosion resistance of the terminal
Different plating layer materials

| | | | | | | | | | | | |
|---|---|---|---|---|---|---|---|---|---|---|---|
| Gold | Silver | Silver- | Graphite- | Graphene- | Silver-gold- | Tin | Nickel | Palladium | Palladium- | Tin-lead | Zinc |
| | | antimony | silver | silver | zirconium | | | | nickel | Alloy | |
| | | Alloy | | | Alloy | | | | Alloy | | |

Number of Times of Plugging And Unplugging (times)

| | | | | | | | | | | | |
|---|---|---|---|---|---|---|---|---|---|---|---|
| 12400 | 11800 | 12200 | 12000 | 12500 | 12000 | 8300 | 8300 | 11100 | 12000 | 10000 | 8500 |

Number of Periods of Corrosion Resistance Test (times)

| | | | | | | | | | | | |
|---|---|---|---|---|---|---|---|---|---|---|---|
| 132 | 127 | 121 | 130 | 124 | 132 | 82 | 87 | 110 | 120 | 112 | 86 |

As can be seen from Table 5, when the material of the plating layer is selected from gold, silver, silver-antimony alloy, palladium, palladium-nickel alloy, graphite-silver, graphene-silver and silver-gold-zirconium alloy, the experimental results highly exceed the standard values, and the performance is relatively stable. When the material of the plating layer is selected from nickel, tin, tin-lead alloy and zinc, the experimental results can also meet the requirements. Therefore, the inventor selects the material of the plating layer as combination of one or more selected from gold, silver, nickel, tin, zinc, tin-lead alloy, silver-antimony alloy, palladium, palladium-nickel alloy, graphite-silver, graphene-silver and silver-gold-zirconium alloy.

In some embodiments, the plating layer includes a bottom layer and a surface layer, and the plating layer is made by a multilayer plating method. After the terminal lamination 3 is machined, there are actually still many gaps and holes on the surface under the microscopic interface, and these gaps and holes are the biggest cause of wear and corrosion of the terminal lamination 3 during use. In this embodiment, it is necessary to plate a bottom layer on the surface of the terminal lamination 3 to fill the gaps and holes on the surface to make the surface of the terminal lamination 3 to be flat and have no holes, and then to plate a surface layer to be bonded more firmly and more smoothly. There are no gaps and holes on the plating layer surface, so that the terminal lamination 3 has better wear resistance, corrosion resistance and electrical performance, thereby greatly prolonging the service life of the terminal lamination 3.

In some embodiments, the plating layer may be provided by means of electroplating, chemical plating, magnetron sputtering or vacuum plating or the like.

Electroplating method refers to a process of plating a thin layer of other metals or alloys on a metal surface by the principle of electrolysis.

Chemical plating refers to a process of metal deposition generated by controllable oxidation-reduction reaction under the catalysis of metals.

Magnetron sputtering refers to that, using the interaction of magnetic field and electric field, the electrons travel in a spiral pattern near the surface of the target, thus increasing the probability of which the electrons hits the argon and produces ions, and the generated ions hits the target surface under the action of electric field and sputters out the target material.

Vacuum plating refers to that, under vacuum conditions, various metal film and non-metal film are deposited on the surface of the parts by means of distillation or sputtering or the like.

In some embodiments, a material of the bottom layer includes one or more selected from gold, silver, nickel, tin, tin-lead alloy and zinc: a material of the surface layer includes one or more selected from gold, silver, nickel, tin, tin-lead alloy, silver-antimony alloy, palladium, palladium-nickel alloy, graphite-silver, graphene-silver and silver-gold-zirconium alloy.

In another embodiment, a thickness of the bottom layer is 0.01 μm to 12 μm. Exemplarily, a thickness of the bottom layer is 0.1 μm to 9 μm.

In another embodiment, a thickness of the surface layer is 0.5 μm to 50 μm. Exemplarily, a thickness of the surface layer is 1 μm to 35 μm.

In order to demonstrate the influence of change of the thickness of the bottom layer of the plating layer on the overall performance of the plug-in terminal 2, the inventor adopts the plug-in terminals 2 of the same specifications and the same materials, and different nickel plating bottom thicknesses and the same silver plating surface layer thickness, and performs a series of temperature rise and corrosion resistance time tests by using the busbars 1 of the same specification, and the experimental results are shown in Table 6.

The temperature rise tests in Table 6 is to apply the same current to the plug-in structure, to detect the temperature at the same position of the terminal lamination 3 before being powered on and after temperature stabilization in a closed environment, to obtain an absolute value of a difference thereof. In this embodiment, a temperature rise greater than 50 K is considered to be unqualified.

The test of corrosion resistance time in the Table 6 refers to, putting the plug-in terminal 2 into a salt fog spraying test chamber to spray salt fog to each position of the plug-in terminal 2 and then taking the plug-in terminal 2 out every 20 hours to clean the plug-in terminal 2 and observe surface corrosion of the plug-in terminal 2, at that time a cycle ends, and when the corrosion area of the surface of the terminal is greater than 10% of the total area, stopping the test and recording the number of cycles at that time. In this embodiment, the number of cycles less than 80 is considered as being unqualified.

TABLE 6
Influence of different thicknesses of the bottom layer of the plating
layer on temperature rise and corrosion resistance: layer (μm)
Different nickel plating thicknesses of the bottom layer (μm)

| | | | | | | | | |
|---|---|---|---|---|---|---|---|---|
| 0.001 | 0.005 | 0.01 | 0.05 | 0.1 | 0.5 | 1 | 3 | 5 |

Temperature rise of busbar (k)

| | | | | | | | | |
|---|---|---|---|---|---|---|---|---|
| 10.2 | 12.2 | 14.9 | 16 | 18.0 | 21.7 | 24.3 | 26.5 | 28.5 |

Number of Periods of Corrosion Resistance Test (times)

| | | | | | | | | |
|---|---|---|---|---|---|---|---|---|
| 69 | 79 | 82 | 95 | 105 | 109 | 112 | 117 | 120 |

Different nickel plating thicknesses of the bottom layer (μm)

| | | | | | | |
|---|---|---|---|---|---|---|
| 6 | 9 | 10 | 11 | 12 | 13 | 15 |

Temperature rise of busbar (k)

| | | | | | | |
|---|---|---|---|---|---|---|
| 31.0 | 35.9 | 40.3 | 43.6 | 44.8 | 56.1 | 60.1 |

Number of Periods of Corrosion Resistance Test (times)

| | | | | | | |
|---|---|---|---|---|---|---|
| 122 | 12 | 121 | 131 | 133 | 126 | 125 |

As can be seen from Table 6, when the nickel plating thicknesses of the bottom layer is smaller than 0.01 μm, the temperature rise of the plug-in structure is qualified, however, because the plating layer is too thin, the number of corrosion resistance cycles of the plug-in terminal 2 is smaller than 80, which does not meet the performance requirement of the plug-in terminal 2. This thus has a great impact on both of the overall performance and service life of the plug-in structure, and may cause the service life of the product to decrease sharply or even failure of the product and combustion accidents in a serious situation. When the nickel plating thicknesses of the bottom layer is greater than 12 μm, because the bottom layer of the plating layer is thick, heat generated by the plug-in structure cannot be dissipated, so that the temperature rise of the plug-in structure is not qualified, and the thick plating layer is easy to fall off the surface of the terminal lamination 3, resulting in a decrease in the number of cycles of corrosion resistance. Therefore, the inventor selects the thicknesses of the bottom layer of the plating layer to be 0.01 μm to 12 μm. Exemplarily, the inventor finds that when the thickness of the bottom layer of the plating layer is 0.1 μm to 9 μm, the combined effect of the temperature rise and corrosion resistance of the plug-in structure is better. Therefore, in order to further improve the safety, reliability and practicality of the product itself, the thickness of the bottom layer of the plating layer is exemplarily 0.1 μm to 9 μm.

In order to demonstrate the influence of change of the thickness of the surface layer of the plating layer on the overall performance of the plug-in structure, the inventor adopts the samples of the plug-in terminal 2 with same specifications and materials, and the same nickel plating bottom thickness and different silver plating surface layer thicknesses, and performs a series of temperature rise and corrosion resistance time tests by using the busbars of the same specification, the experimental method is the same as above and the experimental results are shown in Table 7.

As can be seen from Table 7, when the silver plating thickness of the surface layer is smaller than 0.5 μm, the temperature rise of the plug-in structure is qualified, however, because the plating layer is too thin, the number of corrosion resistance cycles of the plug-in terminal is smaller than 80, which does not meet the performance requirement of the terminal. This thus has a great impact on both of the overall performance and service life of the plug-in structure, and may cause the service life of the product to decrease sharply or even failure of the product and combustion accidents in a serious situation. When the silver plating thickness of the surface layer is greater than 50 μm, because the surface layer of the plating layer is thick, heat generated by the terminal cannot be dissipated, so that the temperature rise is not qualified, and the thick plating layer is easy to fall off the terminal surface, resulting in a decrease in the number of cycles of corrosion resistance. Moreover, because the metal of the surface layer of the plating layer is expensive, the performance may not be improved if a thick plating layer is configured with, thus there is no use value. Therefore, the inventor selects the silver plating thickness of the surface layer to be 0.1 μm to 50 μm. Exemplarily, the inventor finds that when the thickness of the surface layer of the plating layer is 1 μm to 35 μm, the combined effect of the temperature rise and corrosion resistance of the terminal is better. Therefore, in order to further improve the safety, reliability and practicality of the product itself, the thickness of the surface layer of the coating is exemplarily 1 μm to 35 μm.

TABLE 7
Influence of different thicknesses of the surface layer of the
plating layer on temperature rise and corrosion resistance:
Different silver plating thicknesses of the surface layer (μm)

| | | | | | | | | |
|---|---|---|---|---|---|---|---|---|
| 0.1 | 0.5 | 1 | 1.5 | 5 | 10 | 15 | 20 | 25 |

Temperature rise of busbar (k)

| | | | | | | | | |
|---|---|---|---|---|---|---|---|---|
| 11.4 | 13.8 | 15.2 | 17.8 | 21.7 | 23.9 | 25.4 | 28.5 | 31.5 |

Number of Periods of Corrosion Resistance Test (times)

| | | | | | | | | |
|---|---|---|---|---|---|---|---|---|
| 75 | 81 | 91 | 93 | 95 | 97 | 98 | 103 | 105 |

Different silver plating thicknesses of the surface layer (μm)

| | | | | | | | |
|---|---|---|---|---|---|---|---|
| 30 | 35 | 40 | 45 | 50 | 55 | 60 | 65 |

Temperature rise of busbar (k)

| | | | | | | | |
|---|---|---|---|---|---|---|---|
| 35.2 | 38.9 | 42.7 | 45.2 | 48.2 | 52.5 | 53.8 | 69.5 |

Number of Periods of Corrosion Resistance Test (times)

| | | | | | | | |
|---|---|---|---|---|---|---|---|
| 111 | 114 | 117 | 119 | 122 | 126 | 124 | 120 |

In some embodiments, there is plating layer on the connection end 32 of the plug-in structure.

In some embodiments, the plating layer of the plug-in end 31 is made of a material different from that of the plating layer of the connection end 32. From the above description, it can be seen that different metal material plating layers have different conductive effects and corrosion resistance. The metal material plating layers with higher price may achieve better corresponding conductive effect and corrosion resistance, is capable of performing more number of times of plugging and unplugging, and may be used in a more complex environment to obtain a longer service life, but also due to the higher price, the use of these metal material plating layers is limited.

Therefore, at the positions of the plug-in end 31 that is plugged many times and exposed in the use environment, the inventor may use such metal materials such as gold, silver, silver-antimony alloy, graphite-silver, graphene-silver, palladium-nickel alloy, tin-lead alloy or silver-gold-zirconium alloy which have excellent performance but high price as the plating layer materials. The connection end 32 is the location where the wire is connected, and has basically no relative displacement after being connected to the wire, and the connection end 32 is generally protected within the plastic shell, and may not be exposed to the use environment. Therefore, the inventor may use commonly used metals such as tin, nickel and zinc, as the plating layer material of the connection end 32 to reduce the cost of the connection structure.

In some embodiments, the plating layer of the plug-in end 31 has a thickness different

from that of the plating layer of the connection end 32. It can be seen from the above description that the plug-in end 31 is plugged many times, and may be exposed to the use environment. The plating layer may be scratched and corroded by the external environment, and if the plating layer thickness is small, it may be easily scratched or corroded during use. Therefore, the inventor may provide a thicker plating layer at the position of the plug-in end 31 to increase the scratch and corrosion resistance of the plug-in end 31. In addition, since one side of the connection end 32 may not be scratched and thus may not be exposed to the use environment, a plating layer with small thickness can be used, thereby reducing the cost of the connection structure.

In some embodiments, the plugging force between the busbar 1 and the plug-in terminal 2 is 3 N to 150 N, and exemplarily the plugging force between the busbar and the plug-in terminal is 10 N to 95 N. In order to verify the influence of the plugging force between the busbar 1 and the plug-in terminal 2 on the contact resistance and mutual plugging of the busbar and the plug-in terminal 2, the inventor uses the busbar 1 and the plug-in terminal 2 having the same shape and size, and design the plugging force between the busbar and the plug-in terminal 2 as different plugging forces, to observe the contact resistance between the busbar and the plug-in terminal 2 and the situation after multiple times of mutual plugging.

The contact resistance is detected using a micro resistance measurement instrument, which measures the resistance at the contact position between the busbar and the plug-in terminal and reads the numerical value on the micro resistance measurement instrument as the contact resistance between the busbar and the plug-in terminal, and in this embodiment, the contact resistance less than 50 μΩ is ideal.

The mutual plugging between the busbar 1 and the plug-in terminal 2 is tested by performing mutual plugging between the busbar 1 and the plug-in terminal 2 for 50 times, and observing the number of times that falling occurs and the number of times that the plugging fails after plugging and unplugging. The number of times that falling occurs after plugging and unplugging is required to be less than 3, and the number of times that the plugging fails is required to be less than 5.

TABLE 8
Influence of different plugging forces between the busbar and the
plug-in terminal on the contact resistance and mutual plugging:
Plugging forces between the busbar and the plug-in terminal (N)

| | | | | | | | | | | | | | |
|---|---|---|---|---|---|---|---|---|---|---|---|---|---|
| 1 | 3 | 5 | 10 | 25 | 35 | 45 | 55 | 65 | 75 | 95 | 125 | 150 | 155 |

Contact resistance (μΩ)

| | | | | | | | | | | | | | |
|---|---|---|---|---|---|---|---|---|---|---|---|---|---|
| 62 | 49 | 48 | 43 | 37 | 35 | 30 | 26 | 22 | 17 | 14 | 11 | 8 | 6 |

Number of times that falling occurs after plugging and unplugging (number of times)

| | | | | | | | | | | | | | |
|---|---|---|---|---|---|---|---|---|---|---|---|---|---|
| 5 | 1 | 1 | 0 | 0 | 0 | 0 | 0 | 0 | 0 | 0 | 0 | 0 | 0 |

Number of times that the plugging fails (number of times)

| | | | | | | | | | | | | | |
|---|---|---|---|---|---|---|---|---|---|---|---|---|---|
| 0 | 0 | 0 | 0 | 0 | 0 | 0 | 0 | 0 | 0 | 0 | 1 | 3 | 6 |

As can be seen from Table 8, when the plugging force between the busbar 1 and the plug-in terminal 2 is less than 3 N, because the binding force between the busbar 1 and the plug-in terminal 2 is too small, the contact resistance between two needs to be higher than the ideal value, and in addition, the number of times that falling occurs after plugging and unplugging also more than 3, which is regarded as unqualified state. When the plugging force between the busbar 1 and the plug-in terminal 2 is greater than 150 N, the number of times that the plugging fails between the busbar 1 and the plug-in terminal 2 is more than 5, which is also regarded as an unqualified state. Thus the inventor sets the plugging force between the busbar 1 and the plug-in terminal 2 to be 3N to 150 N.

As can be seen from Table 8, when the plugging force between the busbar 1 and the plug-in terminal 2 is 10 N to 95 N, there is neither falling nor plugging failure after plugging and unplugging, and the contact resistance value is also in the ideal range. Therefore, the inventor sets that exemplarily, the plugging force between the busbar 1 and the plug-in terminal 2 is 10 N to 95 N.

In some embodiments, the contact resistance between the busbar 1 and the plug-in terminal 2 is less than 9 mΩ. Generally, high current is required to be conducted between the busbar 1 and the plug-in terminal 2. If the contact resistance between the busbar 1 and the plug-in terminal 2 is greater than 9 mΩ, a large temperature rise may occur at the contact position, and as time goes on, the temperature becomes higher and higher. The temperature between the busbar 1 and the plug-in terminal 2 is too high, which on one hand may cause the thermal expansion rate between the transition layer and the busbar and between the plug-in terminal and the plating layer to be different due to different materials therewith, causing the mechanical deformation to be not synchronized, resulting in internal stress between the transition layer 11 and the busbar 1, and between the plug-in terminal 2 and the plating layer, which may cause the transition layer 11 and the plating layer to fall off in serious cases, and cannot achieve the role of protection. On the other hand, the excessive temperature between the busbar 1 and the plug-in terminal 2 may be transmitted to the insulation layer of the busbar 1 and the insulation layer of the wire connected to the plug-in terminal, which may cause the corresponding insulation layer to melt and cannot play the role of insulation and protection, and may lead to short circuit in serious cases to cause damage to the connection structure, or even burning and other safety accidents. Therefore, the inventor sets that the contact resistance between the busbar 1 and the plug-in terminal 2 is less than 9 mΩ.

In order to verify the influence of the contact resistance between the busbar 1 and the

plug-in terminal 2 on temperature rise and electric conductivity of the plug-in structure, the inventor uses the same busbar 1, and the plug-in terminal 2 with different contact resistances, and performs test of the electric conductivity and temperature rise.

The test of electric conductivity refers to that after the busbar 1 is mutually plugged with the plug-in terminal 2, and the plug-in structure is energized, the electric conductivity at the mutual plugging position is detected, and in this embodiment, the electric conductivity greater than 99% is an ideal value.

The test of temperature rise is to apply the same current to the plug-in structure, to detect the temperature at the same position of the plug-in terminal 2 before being powered on and after temperature stabilization in a closed environment, to obtain an absolute value of a difference thereof. In this embodiment, a temperature rise greater than 50 K is considered to be unqualified.

TABLE 9
Influence of different contact resistances between the busbar and the
plug-in terminal on the electric conductivity and temperature rise
Different contact resistances between the busbar and the plug-in terminal (mΩ)

| | | | | | | | | |
|---|---|---|---|---|---|---|---|---|
| 10 | 9 | 8 | 6 | 4 | 3 | 2 | 1 | 0.5 |

Temperature rise of the plug-in terminal 2 (k)

| | | | | | | | | |
|---|---|---|---|---|---|---|---|---|
| 55 | 48 | 41 | 35 | 29 | 23 | 18 | 14 | 7 |

Electric conductivity of the plug-in structure (%)

| | | | | | | | | |
|---|---|---|---|---|---|---|---|---|
| 98.8 | 99.3 | 99.5 | 99.6 | 99.7 | 99.7 | 99.8 | 99.9 | 99.9 |

As can be seen from Table 9, when the contact resistance between the busbar 1 and the plug-in terminal 2 is greater than 9 mΩ, the temperature rise of the plug-in terminal 2 exceeds 50 K, and the electric conductivity of the plug-in structure is less than 99%, which does not meet the standard requirements. Therefore, the inventor sets that the contact resistance between the busbar 1 and the plug-in terminal 2 is less than 9 mΩ.

In some embodiments, the material of the busbar 1 includes aluminum. In the field of electrical connection, copper wires are used to conduct current, and copper has high electric conductivity and good ductility. However, with the increasing price of copper, the material cost of using copper as wire will become higher and higher. To this end, people begin to look for alternatives to the metallic copper to reduce costs. The content of metallic aluminum in the earth's crust is about 7.73%, after the refining technology is optimized, the price of the metallic aluminum is relatively low, and compared with copper, aluminum is light in weight and is second only to copper in conductivity, and aluminum is capable of replacing some copper in the field of electrical connection. Therefore, it is a developing trend to replace copper with aluminum in the field of automotive electrical connection.

However, because the electrode potential difference between copper and aluminum is large, after copper and aluminum wires are connected directly, electrochemical corrosion may occur between copper and aluminum wires, and aluminum is susceptible to corrosion, resulting in increased resistance in the connection area, which may easily cause serious consequences in the electrical connection, such as functional failure, fire, etc. Therefore, it is necessary to add a transition layer between copper and aluminum, which can reduce the electrode potential difference between copper and aluminum, improve the electrical performance between copper and aluminum, and greatly prolong the service life of the busbar and the plug-in structure.

### Second Solution

The disclosure provides a motor vehicle including the above-described plug-in structure of a busbar and a terminal. Generally, in the field of electrical connection, for the plug-in connection between two cables, it is necessary to crimp or weld the corresponding terminals on the cables, and then the corresponding terminals are mutually plugged to achieve electrically detachable connection. However, the connection between the terminal and the cable may inevitably increase the resistance of the electrical circuit and increase the voltage drop, thereby reducing the performance of the electrical connection. The busbar is directly plugged mutually with the terminal, which saves the terminal crimped on the busbar, can reduce the voltage drop of the electrical circuit, thereby improving the performance of the electrical connection, and prolonging the service life of the plug-in structure.

The foregoing is merely an illustrative embodiment of the invention and is not intended to limit the scope of the disclosure. Any equivalent changes and modifications made by those skilled in the art without departing from the concepts and principles of the present disclosure shall fall within the scope of the present disclosure.

1. A plug-in structure of a busbar and a terminal, wherein the plug-in structure comprises a busbar and a plug-in terminal,
the busbar is provided with a plug-in portion;
the plug-in terminal comprises at least one terminal lamination;
the terminal lamination comprises a plug-in end, and a connection end for being connected to a cable; and
the plug-in portion is constructed to be in plug-in fit with the plug-in end.

2. The plug-in structure of a busbar and a terminal according to claim 1, wherein the plug-in portion is provided with a transition layer; and
a thickness of the transition layer is 0.3 μm to 3000 μm.

3-6. (canceled)

7. The plug-in structure of a busbar and a terminal according to claim 1, wherein the plug-in terminal comprises a plurality of terminal laminations, and the plurality of terminal laminations are stacked.

8. The plug-in structure of a busbar and a terminal according to claim 1, wherein the plug-in end is provided with at least two connection arms, and a plugging slot is arranged between two adjacent connection arms; and
a gap between the connection arms of two adjacent terminal laminations is smaller than 0.2 mm.

9. (canceled)

10. The plug-in structure of a busbar and a terminal according to claim 8, wherein at least part of the connection arm is made of memory alloy; and
the memory alloy has a transition temperature of 40° C. to 70° C., and when the temperature of the connection arms is lower than the transition temperature, the plurality of connection arms are in an expanded state; when the temperature of the connection arms is higher than the transition temperature, the plurality of connection arms are in a clamped state.

11. (canceled)

12. The plug-in structure of a busbar and a terminal according to claim 8, wherein the connection end is provided with a terminal fixing portion, and one end of each of the connection arms is fixedly connected to the terminal fixing portion.

13. (canceled)

14. The plug-in structure of a busbar and a terminal according to claim 8, wherein the connection arms of two adjacent terminal laminations are in contact fit with each other.

15. The plug-in structure of a busbar and a terminal according to claim 8, wherein a plurality of protrusion portions distributed at intervals along an extending direction of the connection arm are provided on an inner side of the connection arm.

16. The plug-in structure of a busbar and a terminal according to claim 1, wherein the connection end comprises a bending extension portion arranged in a plane or a non-plane, with a bending angle of 0° to 180°.

17. The plug-in structure of a busbar and a terminal according to claim 1, wherein the busbar comprises a bending portion through which a main body of the busbar is connected to the plug-in portion.

18. The plug-in structure of a busbar and a terminal according to claim 1, wherein the plug-in portion is provided with a chamfer.

19. The plug-in structure of a busbar and a terminal according to claim 1, wherein the terminal lamination is made of tellurium-copper alloy or beryllium-copper alloy.

20-23. (canceled)

24. The plug-in structure of a busbar and a terminal according to claim 1, wherein there is a plating layer on at least the plug-in end.

25. (canceled)

26. The plug-in structure of a busbar and a terminal according to claim 24, wherein the plating layer comprises a bottom layer and a surface layer.

27. (canceled)

28. (canceled)

29. The plug-in structure of a busbar and a terminal according to claim 26, wherein the plug-in structure of a busbar and a terminal comprises one of:
a thickness of the bottom layer is 0.01 μm to 12 μm; and
a thickness of the surface layer is 0.5 μm to 50 μm.

30-32. (canceled)

33. The plug-in structure of a busbar and a terminal according to claim 24, wherein the connection end of the terminal lamination is provided with a plating layer.

34. The plug-in structure of a busbar and a terminal according to claim 33, wherein the plug-in structure of a busbar and a terminal comprises one of:
the plating layer of the plug-in end is made of a material different from that of the plating layer of the connection end; and
the plating layer of the plug-in end has a thickness different from that of the plating layer of the connection end.

35. (canceled)

36. The plug-in structure of a busbar and a terminal according to claim 1, wherein a plugging force between the busbar and the plug-in terminal is 3 N to 150 N.

37. (canceled)

38. The plug-in structure of a busbar and a terminal according to claim 1, wherein the contact resistance between the busbar and the plug-in terminal is less than 9 mΩ.

39. (canceled)

40. A motor vehicle, wherein the motor vehicle comprises the plug-in structure of a busbar and a terminal according to claim 1.
